(19) United States
(12) Patent Application Publication
(10) Pub. No.: US 2022/0163169 A1
(43) Pub. Date: May 26, 2022

(54) MAINTENANCE APPARATUS FOR CRYOCOOLER AND METHOD FOR MAINTAINING CRYOCOOLER

(71) Applicant: Ulvac Cryogenics Incorporated, Chigasaki-shi (JP)

(72) Inventors: Masamichi Saitoh, Chigasaki-shi (JP); Noboru OKUYAMA, Chigasaki-shi (JP); Yukihiro SHIBATA, Chigasaki-shi (JP); Junpei Yuyama, Chigasaki-shi (JP)

(73) Assignee: Ulvac Cryogenics Incorporated, Chigasaki-shi (JP)

(21) Appl. No.: 17/506,989

(22) Filed: Oct. 21, 2021

(30) Foreign Application Priority Data
Nov. 25, 2020 (JP) 2020-195055

(51) Int. Cl. F17C 13/00; B25J 21/02

(52) U.S. Cl. CPC F17C 13/002; F17C 2260/015; B25J 21/02

(57) ABSTRACT

A maintenance apparatus for a cryocooler includes a glovebox, a container, and a lid. The glovebox is configured to be joined to a cooling subject coupled to a cylinder of the cryocooler. The glovebox defines a first glovebox chamber that accommodates a cryocooler part excluding the cylinder. The cryocooler part includes a displacer of the cryocooler dismounted from the cylinder. The container is disposed in the first glovebox chamber and configured to accommodate the cryocooler part. The lid is disposed in the first glovebox chamber. The lid is configured to disconnect a cylinder chamber of the cylinder from the first glovebox chamber when the cooling subject is joined to the glovebox.

### CROSS REFERENCE TO RELATED APPLICATIONS

This application claims priority to Japanese application number 2020-195055, filed Nov. 25, 2020. The entire contents of which is incorporated herein by reference in their entirety.

### BACKGROUND

### Field

The following description relates to a maintenance apparatus for a cryocooler and a method for maintaining a cryocooler.

### Description of Related Art

When performing maintenance of a cryocooler installed on a cooling subject, parts of the cryocooler are replaced using a glovebox. In the maintenance, a glovebox that accommodates a replacing cryocooler part is attached to the cooling subject. At this time, the glovebox is attached to the cooling subject so that the cryocooler installed on the cooling subject is partially exposed in a glovebox chamber defined by the glovebox. Helium gas is supplied to the glovebox chamber. Then, a cryocooler part excluding a cylinder is dismounted from the cryocooler installed on the cooling subject and is accommodated in the glovebox chamber. The replacing cryocooler part excluding a cylinder is mounted on a cylinder coupled to the cooling subject (refer to Japanese Laid-Open Patent Publication Nos. 2004-169991 and 2000-146333).

### SUMMARY

The cylinder is exposed in the glovebox chamber during a period from when the cryocooler part that is subject to replacement is dismounted from the cylinder of the cryocooler until a new replacing cryocooler part is mounted on the cylinder. Even when the gas in the glovebox is replaced with helium gas, moisture exists in the glovebox. Collection of the moisture on the cylinder adversely affects the cooling efficiency. Hence, it is preferred to limit collection of moisture on the cylinder. There is a need to limit collection of moisture on a cryocooler during the maintenance of the cryocooler.

The present disclosure provides a maintenance apparatus for a cryocooler and a method for maintaining a cryocooler that limit collection of moisture on the cryocooler.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An embodiment of a maintenance apparatus for a cryocooler includes a glovebox, a container, and a lid. The glovebox is configured to be joined to a cooling subject coupled to a cylinder of the cryocooler. The glovebox defines a first glovebox chamber that accommodates a cryocooler part excluding the cylinder. The cryocooler part includes a displacer of the cryocooler dismounted from the cylinder. The container is disposed in the first glovebox chamber and configured to accommodate the cryocooler part. The lid is disposed in the first glovebox chamber. The lid is configured to disconnect a cylinder chamber of the cylinder from the first glovebox chamber when the cooling subject is joined to the glovebox.

An embodiment of a method for maintaining a cryocooler includes joining a glovebox defining a first glovebox chamber to a cooling subject coupled to a cylinder of the cryocooler, dismounting a displacer of the cryocooler from the cylinder, accommodating the displacer in a container disposed in the first glovebox chamber, and disconnecting the first glovebox chamber from a cylinder chamber of the cylinder using a lid provided in the first glovebox chamber.

According to the maintenance apparatus and the maintenance method described above, the lid disconnects the cylinder chamber from the first glovebox chamber. Thus, entrance of moisture into the cylinder chamber is limited. In addition, the cryocooler part including the displacer is accommodated in the container in the first glovebox chamber. Thus, collection of moisture on the displacer is limited when the displacer is taken out from the cylinder chamber.

Other features and aspects will be apparent from the following detailed description, the drawings, and the claims.

### BRIEF DESCRIPTION OF THE DRAWINGS

FIG. 1 is a schematic diagram showing a structure of a first glovebox of a cryocooler maintenance apparatus in a first embodiment.

FIG. 2 is a process diagram showing a cryocooler maintenance method in the first embodiment.

FIG. 3 is a process diagram showing the cryocooler maintenance method in the first embodiment.

FIG. 4 is a process diagram showing the cryocooler maintenance method in the first embodiment.

FIG. 5 is a process diagram showing the cryocooler maintenance method in the first embodiment.

FIG. 6 is a process diagram showing the cryocooler maintenance method in the first embodiment.

FIG. 7 is a process diagram showing the cryocooler maintenance method in the first embodiment.

FIG. 8 is a process diagram showing a cryocooler maintenance method in a second embodiment.

FIG. 9 is a process diagram showing the cryocooler maintenance method in the second embodiment.

FIG. 10 is a process diagram showing the cryocooler maintenance method in the second embodiment.

FIG. 11 is a process diagram showing the cryocooler maintenance method in the second embodiment.

FIG. 12 is a process diagram showing the cryocooler maintenance method in the second embodiment.

FIG. 13 is a process diagram showing the cryocooler maintenance method in the second embodiment.

FIG. 14 is a schematic diagram showing a structure of a glovebox of a cryocooler maintenance apparatus in a third embodiment.

FIG. 15 is a process diagram showing the cryocooler maintenance method in the third embodiment.

FIG. 16 is a process diagram showing the cryocooler maintenance method in the third embodiment.

FIG. 17 is a process diagram showing the cryocooler maintenance method in the third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

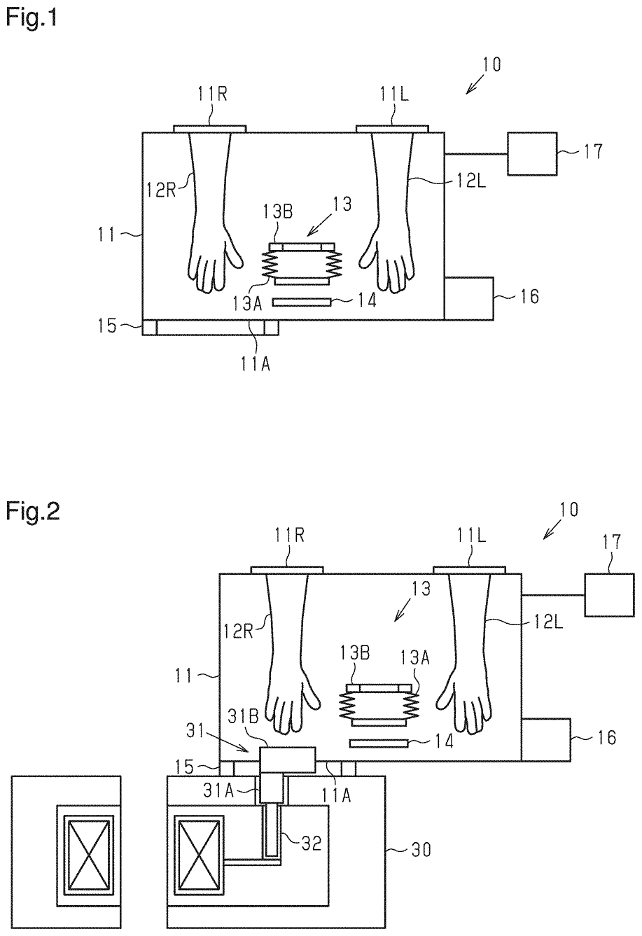

A first embodiment of an apparatus and a method for maintaining a cryocooler will now be described with reference to FIGS. 1 to 7. The apparatus and the method for maintaining a cryocooler will be sequentially described below.

In the present disclosure, the apparatus and the method for maintaining a cryocooler performs maintenance of a cryocooler installed on a cooling subject. In the present disclosure, “the cooling subject” refers to a subject that is cooled by the cryocooler. The type of the cooling subject is not particularly limited. For example, the cooling subject may be a device including a superconducting magnet. In an example, a device including a superconducting magnet may be a nuclear magnetic resonance device. However, the cooling subject is not limited to a particular type. Also, the type of the cryocooler is not particularly limited. In an example, the cryocooler may be a Gifford-McMahon cryocooler. However, the cryocooler may be any other cryocoolers that are capable of cooling the cooling subject and is not limited to a particular type. The cryocooler may include, for example, a displacer (i.e., piston), a cylinder that accommodates the displacer, and a driver that drives the displacer. In a cryocooler such as that described above, the displacer moves back and forth in the cylinder so that a refrigeration cycle is performed.

In the present disclosure, the apparatus and the method for maintaining the cryocooler performs a process including replacement of a cryocooler part excluding the cylinder. In the present disclosure, “the cryocooler part excluding the cylinder” refers to a cryocooler part on which the maintenance is performed and may also be referred to as a maintenance subject or a replacement subject in the following description. The cryocooler part excluding the cylinder, that is, the maintenance subject or the replacement subject, may be only the displacer or both the displacer and the driver.

Cryocooler Maintenance Apparatus

A maintenance apparatus 10 for a cryocooler will now be described with reference to FIG. 1. The maintenance apparatus 10 of the first embodiment includes a first glovebox 11 shown in FIG. 1. The maintenance apparatus 10 may further include a second glovebox 21 shown in FIG. 4. The first glovebox 11 and the second glovebox 21 have the same components used for maintaining the cryocooler but are used at different time points during the maintenance of the cryocooler. Hereafter, the first glovebox 11 and the components disposed in the first glovebox 11 will be described. The second glovebox 21 and the components in the second glovebox 21 will not be described in detail.

FIG. 2 shows the maintenance apparatus 10, a cooling subject 30, and a first cryocooler 31 installed on the cooling subject 30. Although not restrictive, the cooling subject 30 is, for example, a device including a superconducting magnet and may be nuclear magnetic resonance device. Although not restrictive, the first cryocooler 31 is, for example, a Gifford-McMahon cryocooler.

The first cryocooler 31 includes a first displacer 31A, a first driver 31B that drives the first displacer 31A, and a cylinder 32 into which the first displacer 31A is inserted. When the first cryocooler 31 is installed on the cooling subject 30, the first driver 31B may be exposed from the cylinder 32. The cylinder 32 is coupled to the cooling subject 30. The cylinder 32 includes a cylinder chamber that accommodates the first displacer 31A.

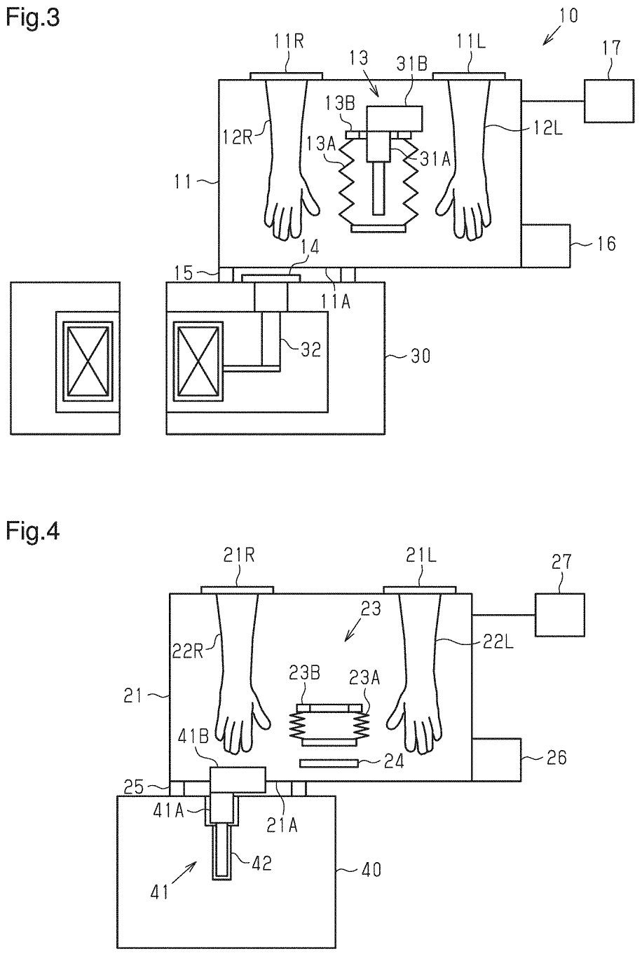

As shown in FIG. 1, the maintenance apparatus 10 includes the first glovebox 11, a first container 13, and a first lid 14. The first glovebox 11 defines a first glovebox chamber in the first glovebox 11. The first container 13 is disposed in the first glovebox chamber. The first container 13 is configured to accommodate at least the first displacer 31A (refer to FIG. 3). The first container 13 may be configured to accommodate both the first displacer 31A and the first driver 31B. The first lid 14 is disposed in the first glovebox chamber. The first lid 14 is configured to seal the opening of the cylinder 32 (i.e., the cylinder chamber) when the first displacer 31A is dismounted from the cylinder 32. When the first glovebox 11 is joined to the cooling subject 30 and the first displacer 31A is dismounted from the cylinder 32, the first glovebox chamber is connected to the cylinder chamber of the cylinder 32. In this state, when the opening of the cylinder 32 is closed by the first lid 14, the cylinder chamber is sealed, and the cylinder chamber is disconnected from the first glovebox chamber (FIG. 3).

The sealing of the cylinder chamber with the first lid 14 disconnects the cylinder chamber from the first glovebox chamber. Thus, even when moisture exists in the first glovebox chamber, collection of the moisture on the cylinder 32 is limited. In addition, the first displacer 31A is accommodated in the first container 13 disposed in the first glovebox chamber. Thus, collection of the moisture on the cooled first displacer 31A is limited.

The first glovebox 11 includes a first insertion opening 11R and a second insertion opening 11L. A first glove 12R is disposed in the first glovebox 11 and attached to the first insertion opening 11R. A second glove 12L is disposed in the first glovebox 11 and attached to the second insertion opening 11L.

The first glovebox 11 has a first coupling hole 11A. The first coupling hole 11A is configured to connect the first glovebox chamber to the cylinder chamber. The first glovebox 11 includes an attachment portion 15 located on its outer surface. The attachment portion 15 surrounds the first coupling hole 11A. The attachment portion 15 hermetically attaches the first glovebox 11 to the cooling subject 30. As shown in FIG. 2, when the first glovebox 11 is attached to the cooling subject 30 by the attachment portion 15, the space surrounded by the attachment portion 15 between the first glovebox 11 and the cooling subject 30 is connected to the first glovebox chamber through the first coupling hole 11A. Thus, after the first glovebox 11 is joined to the cooling subject 30, when the first driver 31B and the first displacer 31A are dismounted from the cylinder 32, the first glovebox chamber is connected to the cylinder chamber through the first coupling hole 11A.

The attachment portion 15 projects in a direction away from the outer surface of the first glovebox 11. The attachment portion 15 has a closed shape surrounding the first coupling hole 11A. The attachment portion 15 is configured to, when attached to the cooling subject 30, seal joined parts between the attachment portion 15 and the cooling subject 30. For example, the attachment portion 15 has a part configured to contact the cooling subject 30 including a sealing part. The part of the attachment portion 15 configured to contact the cooling subject 30 is, for example, a distal end of the attachment portion 15 in a direction in which the attachment portion 15 projects.

As described above, the first container 13 and the first lid 14 are disposed in the first glovebox chamber (refer to FIG. 1). The first container 13 includes a stretchable portion 13A. The stretchable portion 13A defines a space in the first container 13 for accommodating the first displacer 31A (refer to FIG. 3). Alternatively, the stretchable portion 13A may define a space for accommodating both the first displacer 31A and the first driver 31B. When the first displacer 31A or both the first displacer 31A and the first driver 31B are not accommodated in the first container 13, the stretchable portion 13A may be compressed to reduce the size of the first container 13. Thus, when accommodating the first displacer 31A or both the first displacer 31A and the first driver 31B in the first container 13, the task space is enlarged in the first glovebox 11. This allows for reduction in the entire size of the first glovebox 11.

The first container 13 includes a sealing portion 13B. When the first displacer 31A or both the first displacer 31A and the first driver 31B are accommodated in the first container 13, the sealing portion 13B seals an opening of the first container 13. This further limits collection of moisture on the first displacer 31A accommodated in the first container 13.

In the first embodiment, the sealing portion 13B is disposed around the opening of the stretchable portion 13A. When the first displacer 31A is accommodated in the stretchable portion 13A, the sealing portion 13B is fastened to a flange of the first driver 31B to seal the opening (inner space) of the stretchable portion 13A including the first displacer 31A. When both the first displacer 31A and the first driver 31B are accommodated in the stretchable portion 13A, for example, a separate sealing member may be provided in the first glovebox 11, and the opening of the stretchable portion 13A may be sealed using the sealing member and the sealing portion 13B.

The first lid 14 is formed of a member capable of sealing the cylinder chamber and disconnecting the cylinder chamber from the first glovebox chamber. The first lid 14 is, for example, a plate-shaped flange including a peripheral sealant. The sealant is, for example, an elastic member. The sealant may be formed of, for example, resin or rubber.

The maintenance apparatus 10 further includes an evacuation unit 16 and a gas supply unit 17. The evacuation unit 16 is connected to the first glovebox 11. The evacuation unit 16 evacuates the first glovebox chamber defined by the first glovebox 11. The evacuation unit 16 includes, for example, a pump and a valve. The gas supply unit 17 is connected to the first glovebox 11. The gas supply unit 17 supplies an inert gas to the first glovebox chamber. The gas supply unit 17 includes, for example, an inert gas container and a valve. The inert gas may be, for example, helium gas.

Cryocooler Maintenance Method

A method for maintaining the cryocooler will now be described with reference to FIGS. 2 to 7.

The maintenance method includes attaching, for example, fastening, the first glovebox 11 to the cooling subject 30 so that the first driver 31B of the first cryocooler 31 coupled to the cooling subject 30 is exposed in the first glovebox chamber. The maintenance method further includes receiving the first displacer 31A into the first glovebox chamber and sealing the cylinder chamber of the cylinder 32 coupled to the cooling subject 30. In the example shown in FIG. 2, when the first glovebox 11 is attached to the cooling subject 30, the first driver 31B of the first cryocooler 31 coupled to the cooling subject 30 is exposed in the first glovebox chamber defined by the first glovebox 11. The first driver 31B may be accommodated in the first glovebox chamber. The first displacer 31A, which is the maintenance subject, is dismounted from the cylinder 32 coupled to the cooling subject 30. The first displacer 31A is received in the first glovebox chamber. The first displacer 31A is accommodated in the first container 13 disposed in the first glovebox 11. Subsequently, the first lid 14, which is disposed in the first glovebox 11, is used to close the opening of the cylinder 32 coupled to the cooling subject 30. This seals the cylinder chamber and disconnects the cylinder chamber from the first glovebox chamber. The maintenance method will be described below in detail with reference to FIGS. 2 to 7.

As shown in FIG. 2, in the cryocooler maintenance method, the first glovebox 11 is joined to the cooling subject 30. At this time, the attachment portion 15 of the first glovebox 11 is used to join the first glovebox 11 to the cooling subject 30. As a result, the first driver 31B of the first cryocooler 31 fastened to the cooling subject 30 is exposed in the first glovebox chamber of the first glovebox 11. The first displacer 31A is inserted into the cylinder 32. In an example, the first displacer 31A and the first driver 31B are the replacement subject. In the following example, replacement of the first displacer 31A and the first driver 31B with a new displacer and a new driver will be described.

As shown in FIG. 3, the first displacer 31A is taken out from the cylinder 32, and the first displacer 31A or both the first displacer 31A and the first driver 31B are received in the first container 13. At this time, a person performing the maintenance of the first cryocooler 31, for example, inserts one hand into the first glove 12R through the first insertion opening 11R and the other hand into the second glove 12L through the second insertion opening 11L. With the first glove 12R and the second glove 12L worn, the person draws the first displacer 31A out of the cylinder 32. The person stretches the stretchable portion 13A from a compressed state (refer to FIG. 2) and accommodates the first displacer 31A or both the first displacer 31A and the first driver 31B in the stretchable portion 13A. The person seals the opening of the stretchable portion 13A with the sealing portion 13B.

In addition, after drawing the first displacer 31A out of the cylinder 32, the person seals the opening of the cylinder 32 with the first lid 14.

The second glovebox 21 shown in FIG. 4 may be used in the replacement process. FIG. 4 shows the second glovebox 21, which differs from the first glovebox 11, joined to a precooling device 40 configured to cool a second cryocooler 41 serving as a new cryocooler.

As shown in FIG. 4, a second container 23 is disposed in the second glovebox 21. As described above, the first container 13 is configured to accommodate the first displacer 31A or both the first displacer 31A and the first driver 31B, which are dismounted from the cylinder 32 coupled to the cooling subject 30 (refer to FIG. 2). In the same manner, the second container 23 is configured to accommodate a second displacer 41A or both the second displacer 41A and a second driver 41B, which will be newly mounted on the cooling subject 30. The second container 23 includes a stretchable portion 23A and a sealing portion 23B in the same manner as the first container 13. The stretchable portion 23A defines a space in the second container 23 for accommodating the second displacer 41A or both the second displacer 41A and the second driver 41B. The stretchable portion 23A is compressed when the second displacer 41A or both the second displacer 41A and the second driver 41B are not accommodated in the stretchable portion 23A.

As described above, when the maintenance apparatus 10 includes the two gloveboxes 11 and 21, the dismounting of the cryocooler part as the replacement subject may be performed in the first glovebox 11, and the mounting of the new cryocooler part may be performed in the second glovebox 21. Thus, the size of each of the gloveboxes 11 and 21 may be reduced as compared to when the dismounting of the first displacer 31A and the first driver 31B and the mounting of the second displacer 41A and the second driver 41B are performed at the same time using one glovebox. This reduces the total space needed for the maintenance. In addition, when the two gloveboxes 11 and 21 are used, the cooling subject 30 may be separated by a sufficient distance from the precooling device 40 configured to cool the new cryocooler (second cryocooler 41).

The second glovebox 21 includes a first insertion opening 21R and a second insertion opening 21L in the same manner as the first glovebox 11. A first glove 22R is connected to the first insertion opening 21R. A second glove 22L is connected to the second insertion opening 21L. A second lid 24 is disposed in the second glovebox 21.

The second glovebox 21 has a second connection hole 21A. The second glovebox 21 includes an attachment portion 25 located on its outer surface. The attachment portion 25 has a closed shape surrounding the second connection hole 21A. The attachment portion 25 projects in a direction away from the outer surface of the second glovebox 21 in the same manner as the attachment portion 15 of the first glovebox 11.

The second glovebox 21 is connected to an evacuation unit 26 and a gas supply unit 27 in the same manner as the first glovebox 11. The evacuation unit 26 evacuates a second glovebox chamber defined by the second glovebox 21. The evacuation unit 26 includes, for example, a pump and a valve. The gas supply unit 27 supplies an inert gas to the second glovebox chamber. The gas supply unit 27 includes, for example, an inert gas container and a valve. The inert gas may be, for example, helium gas.

The second glovebox 21 is joined to the precooling device 40 by the attachment portion 25. The precooling device 40 includes the second cryocooler 41. The precooling device 40 drives the second cryocooler 41 to cool the second cryocooler 41. When the second glovebox 21 is joined to the precooling device 40, the second cryocooler 41 is cooled by being driven.

The second cryocooler 41 includes the second displacer 41A, the second driver 41B that drives the second displacer 41A, and a cylinder 42 into which the second displacer 41A is inserted. When the second cryocooler 41 is attached to the precooling device 40, the second driver 41B may be exposed form the cylinder 42. The second cryocooler 41 may be a Gifford-McMahon cryocooler in the same as the first cryocooler 31.

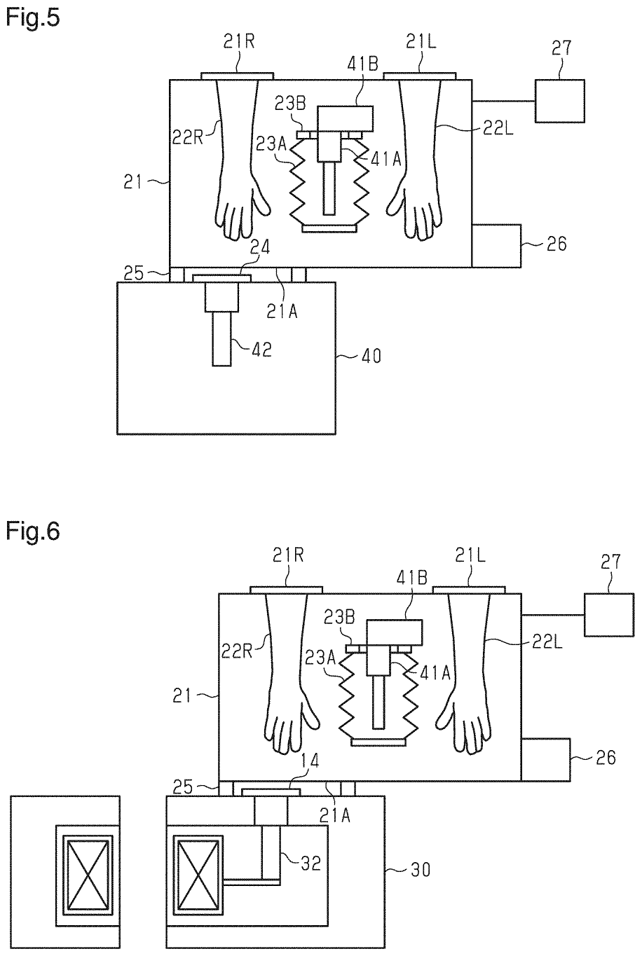

As shown in FIG. 5, the second displacer 41A is taken out from the cylinder 42. The second displacer 41A or both the second displacer 41A and the second driver 41B are received in the second container 23. At this time, a person performing the maintenance, for example, inserts one hand into the first glove 22R through the first insertion opening 21R and the other hand into the second glove 22L through the second insertion opening 21L. With the first glove 22R and the second glove 22L worn, the person draws the second displacer 41A out of the cylinder 42. The person stretches the stretchable portion 23A from a compressed state (refer to FIG. 4) and accommodates the second displacer 41A or both the second displacer 41A and the second driver 41B of the second cryocooler 41 in the stretchable portion 23A. The person seals the opening of the stretchable portion 23A with the sealing portion 23B.

In addition, after drawing the second displacer 41A out of the cylinder 42, the person seals the opening of the cylinder 42 with the second lid 24.

FIG. 6 shows the second glovebox 21 accommodating the second cryocooler 41 (the second displacer 41A and the second driver 41B) and joined to the cooling subject 30.

As shown in FIG. 6, after the second displacer 41A or both the second displacer 41A and the second driver 41B are accommodated in the second container 23 disposed in the second glovebox 21, the second glovebox 21 is disjoined from the precooling device 40 (refer to FIG. 5) and joined to the cooling subject 30. At this time, the attachment portion 25 of the second glovebox 21 is use to join the second glovebox 21 to the cooling subject 30. After the first glovebox 11 is disjoined from the cooling subject 30, the second glovebox 21 is joined to the cooling subject 30. As described above, the opening of the cylinder 32 coupled to the cooling subject 30 is closed by the first lid 14. When replacing the first glovebox 11 with the second glovebox 21, air containing moisture may flow into the second glovebox 21. However, the air containing moisture will not flow into the second container 23 because the second displacer 41A or both the second displacer 41A and the second driver 41B are accommodated in the second container 23 and the opening of the stretchable portion 23A is sealed by the sealing portion 23B. In addition, the cylinder chamber of the cylinder 32 is sealed and guarded by the first lid 14. Thus, the air containing moisture will also not flow into the cylinder chamber.

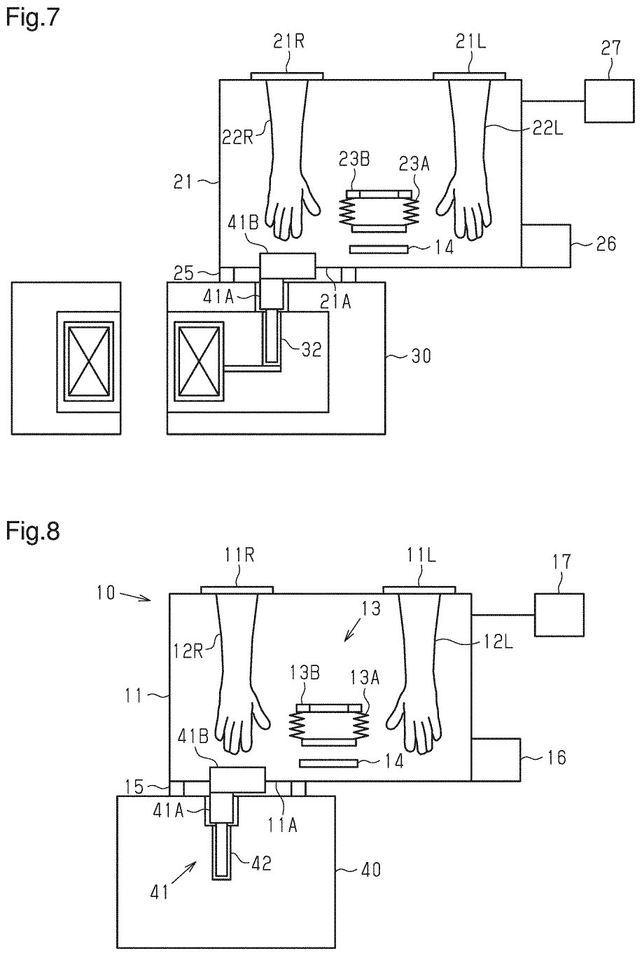

As shown in FIG. 7, after the second glovebox 21 is evacuated to a vacuum state, the inert gas is supplied to the second glovebox 21. Then, the second displacer 41A, which is accommodated in the second container 23, is inserted into the cylinder 32. At this time, the person, for example, inserts one hand into the first glove 22R through the first insertion opening 21R and the other hand into the second glove 22L through the second insertion opening 21L. With the first glove 22R and the second glove 22L worn, the person draws the second displacer 41A or both the second displacer 41A and the second driver 41B out of the second container 23. The person removes the first lid 14 from the opening of the cylinder 32 and inserts the second displacer 41A into the cylinder 32. This completes the task for replacing the first displacer 31A and the first driver 31B of the first cryocooler 31 installed on the cooling subject 30 with the new second displacer 41A and the new second driver 41B.

As described above, the first embodiment of the maintenance apparatus and the maintenance method has the following advantages.

(1) The first lid 14 disconnects the cylinder chamber from the first glovebox chamber. Thus, entrance of moisture into the cylinder chamber is limited. In addition, the first displacer 31A or both the first displacer 31A and the first driver 31B are accommodated in the first container 13 disposed in the first glovebox chamber. Thus, collection of moisture on the cooled first displacer 31A is limited.

(2) When the first displacer 31A or both the first displacer 31A and the first driver 31B are not accommodated in the first container 13, the stretchable portion 13A may be compressed. Thus, when accommodating the first displacer 31A or both the first displacer 31A and the first driver 31B in the first container 13, the task space is enlarged in the first glovebox 11. This allows for reduction in the entire size of the first glovebox 11. When there is enough room in the first glovebox 11 for the task space, the stretchable portion 13A may have a fixed tubular shape.

(3) When the first displacer 31A or both the first displacer 31A and the first driver 31B are accommodated in the first container 13, the sealing portion 13B seals the accommodation space of the first container 13. Thus, when the first glovebox 11 is separated from the cooling subject 30, even if air containing moisture flows into the first glovebox 11, collection of the moisture on the first displacer 31A accommodated in the first container 13 is limited.

(4) The maintenance apparatus 10 includes the two gloveboxes 11 and 21. Thus, the size of each of the gloveboxes 11 and 21 may be reduced as compared to when one glovebox is used. This reduces the total space needed for the maintenance. In addition, the use of the two gloveboxes 11 and 21 allows the cooling subject 30 to be separated by a sufficient distance from the precooling device 40 of the second cryocooler 41.

### Second Embodiment

A second embodiment of an apparatus and a method for maintaining a cryocooler will now be described with reference to FIGS. 8 to 13. The second embodiment differs from the first embodiment in that a cryocooler maintenance apparatus includes only one glovebox. The differences will be described in detail. The second embodiment of the cryocooler maintenance apparatus includes a glovebox having the same structure of the first glovebox described in the first embodiment. The structure of the glovebox will not be described in detail. Only the cryocooler maintenance method will be described.

Cryocooler Maintenance Method

As shown in FIG. 8, in the second embodiment of a cryocooler maintenance method, the first glovebox 11 is joined to the precooling device 40 by the attachment portion 15. The second cryocooler 41 is coupled to the precooling device 40. The precooling device 40 drives the second cryocooler 41 to cool the second cryocooler 41. When the first glovebox 11 is joined to the precooling device 40, the second cryocooler 41 is cooled by being driven. The second cryocooler 41 includes the second displacer 41A, the second driver 41B, and the cylinder 42. The second displacer 41A is inserted into the cylinder 42. The second driver 41B is exposed from the cylinder 42.

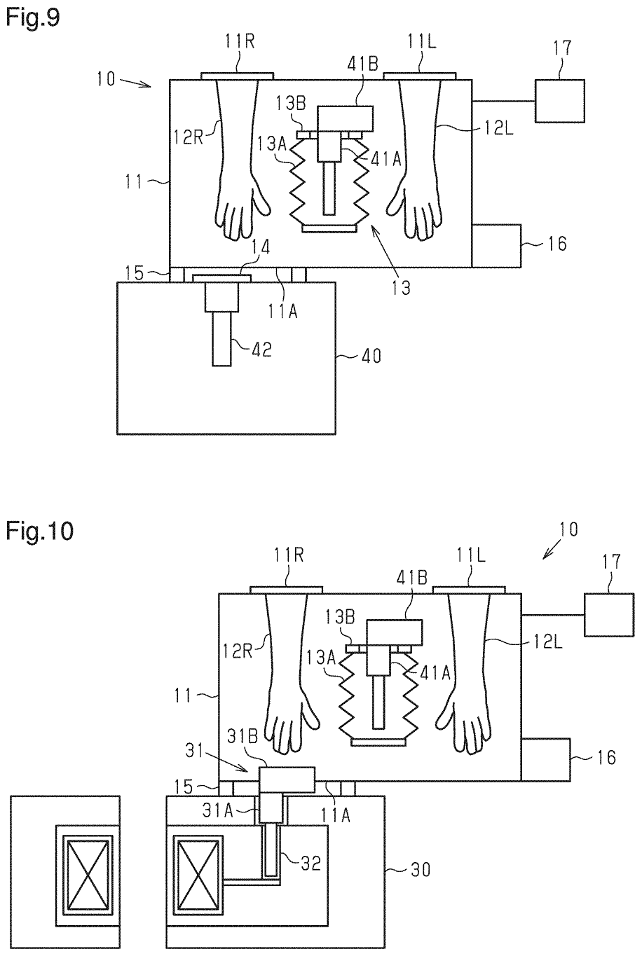

As shown in FIG. 9, the second displacer 41A is taken out from the cylinder 42. The second displacer 41A or both the second displacer 41A and the second driver 41B are received in the first container 13. At this time, with the first glove 12R and the second glove 12L worn, a person performing the maintenance draws out the second displacer 41A from the cylinder 42. The person stretches the stretchable portion 13A from a compressed state (refer to FIG. 8) and accommodates the second displacer 41A or both the second displacer 41A and the second driver 41B in the stretchable portion 13A. The person seals the opening of the stretchable portion 13A with the sealing portion 13B. In addition, after drawing the second displacer 41A out of the cylinder 42, the person seals the opening of the cylinder 42 with the first lid 14.

As shown in FIG. 10, after the first glovebox 11, which accommodates the second displacer 41A and the second driver 41B, is disjoined from the precooling device 40 (refer to FIG. 9), the first glovebox 11 is joined to the cooling subject 30. At this time, the attachment portion 15 of the first glovebox 11 is used to join the first glovebox 11 to the cooling subject 30. As a result, the first driver 31B of the cryocooler 31 fastened to the cooling subject 30 is exposed in the first glovebox chamber of the first glovebox 11. The first displacer 31A is inserted into the cylinder 32. In this example, the first displacer 31A and the first driver 31B are subject to replacement with a new displacer (second displacer 41A) and a new driver (second driver 41B).

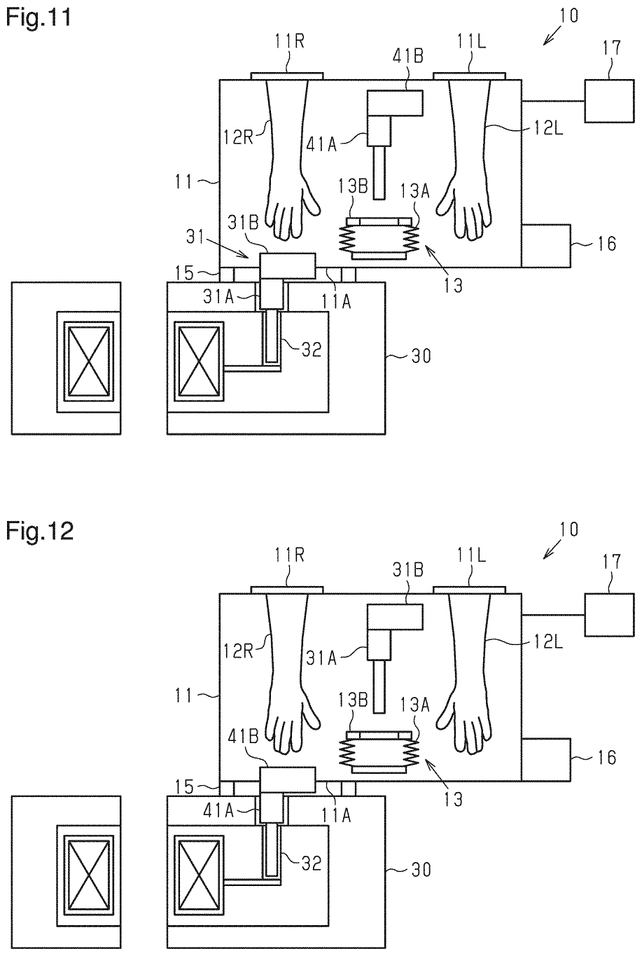

As shown in FIG. 11, the first glovebox 11 is evacuated to a vacuum state, the inert gas is supplied to the first glovebox 11. Then, the second displacer 41A or both the second displacer 41A and the second driver 41B are taken out from the first container 13 so that the first displacer 31A and the first driver 31B are replaced with the second displacer 41A and the second driver 41B. Also, the first displacer 31A is taken out from the cylinder 32. The first displacer 31A taken out from the cylinder 32 is disposed in the first glovebox 11.

As shown in FIG. 12, the second displacer 41A, which is accommodated in the first glovebox 11, is inserted into the cylinder 32 of the cooling subject 30. The person inserts the second displacer 41A into the cylinder 32.

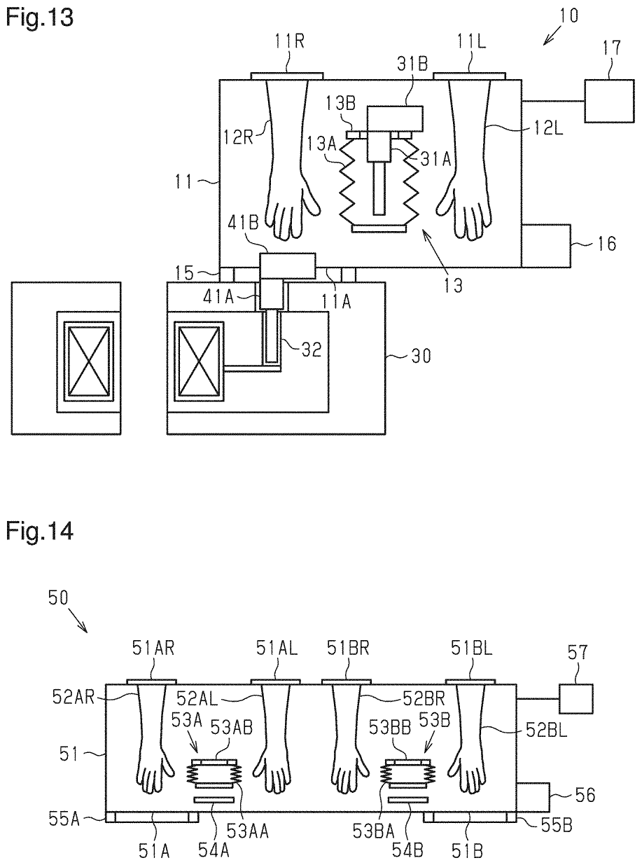

As shown in FIG. 13, the first displacer 31A or both the first displacer 31A and the first driver 31B are received in the first container 13. At this time, the person stretches the stretchable portion 13A from a compressed state (refer to FIG. 12) and accommodates the first displacer 31A or both the first displacer 31A and the first driver 31B in the stretchable portion 13A. The person seals the opening of the stretchable portion 13A with the sealing portion 13B.

As described above, the second embodiment of the maintenance apparatus and the maintenance method has the following advantages.

(5) The maintenance apparatus 10 includes only the first glovebox 11. Thus, the number of components of the maintenance apparatus 10 is reduced as compared to the first embodiment in which the maintenance apparatus 10 includes the first glovebox 11 and the second glovebox 21.

### Third Embodiment

A third embodiment of an apparatus and a method for maintaining a cryocooler will now be described with reference to FIGS. 14 to 17. The third embodiment differs from the first embodiment in that the cryocooler maintenance apparatus includes only one glovebox. The differences will be described in detail. The apparatus and the method for maintaining a cryocooler will be sequentially described below.

Cryocooler Maintenance Apparatus

A maintenance apparatus 50 for a cryocooler will now be described with reference to FIG. 14.

As shown in FIG. 14, the maintenance apparatus 50 includes a glovebox 51. The glovebox 51 includes two pairs of insertion openings. One of the pairs of insertion openings includes a first insertion opening 51AR and a second insertion opening 51AL. The other pair of insertion openings includes a first insertion opening 51BR and a second insertion opening 51BL.

A first glove 52AR is attached to the first insertion opening 51AR. A second glove 52AL is attached to the second insertion opening 51AL. A first glove 52BR is attached to the first insertion opening 51BR. A second glove 52BL is attached to the second insertion opening 51BL. In the third embodiment of the maintenance apparatus 50, one person may perform the maintenance task, or two people may simultaneously perform the maintenance task. Since the maintenance apparatus 50 allows two people to simultaneously perform the maintenance task, the time taken for the maintenance is shortened as compared to a maintenance apparatus including two gloveboxes.

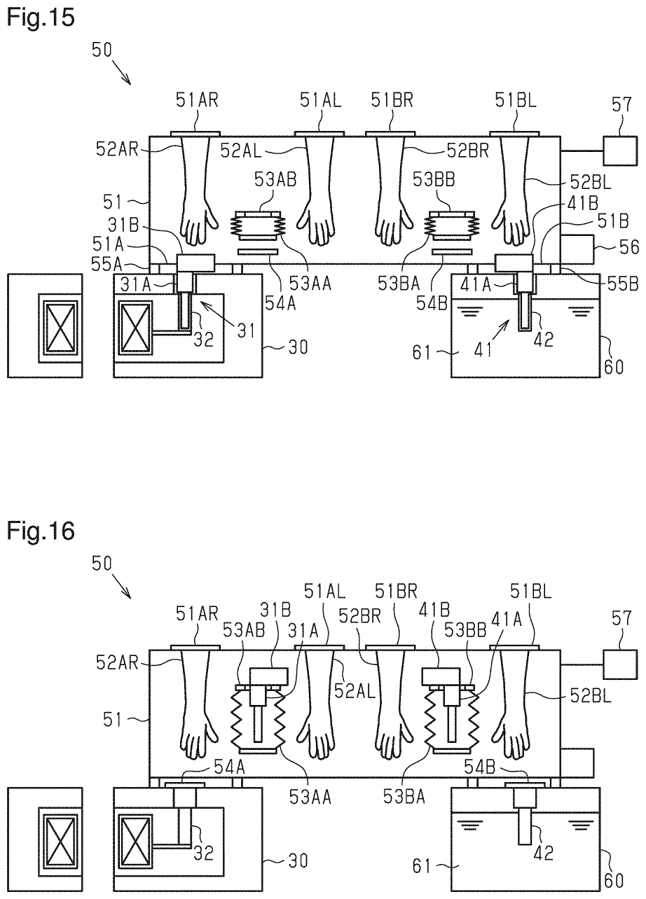

The glovebox 51 defines a glovebox chamber in which a first container 53A, a second container 53B, a first lid 54A, and a second lid 54B are disposed. The containers 53A and 53B are configured to accommodate the cryocoolers 31 and 41, respectively (refer to FIG. 15). The lids 54A and 54B seal the openings of the cylinder chambers of the cryocoolers 31 and 41 (refer to FIG. 15) to disconnect the cylinder chambers from the glovebox chamber of the glovebox 51. The containers 53A and 53B include stretchable portions 53AA and 53BA and sealing portions 53AB and 53BB in the same manner as the containers 13 and 23 of the first embodiment.

The glovebox 51 has a first coupling hole 51A and a second coupling hole 51B. The glovebox 51 includes a first attachment portion 55A and a second attachment portion 55B on its outer surface. The first attachment portion 55A has a closed shape surrounding the first coupling hole 51A. The first attachment portion 55A projects in a direction away from the outer surface of the glovebox 51. The second attachment portion 55B has a closed shape surrounding the second coupling hole 51B. The second attachment portion 55B projects in a direction away from the outer surface of the glovebox 51.

The maintenance apparatus 50 includes an evacuation unit 56 and a gas supply unit 57. The evacuation unit 56 is connected to the glovebox 51. The evacuation unit 56 evacuates the glovebox chamber of the glovebox 51. The evacuation unit 56 includes, for example, a pump and a valve. The gas supply unit 57 is connected to the glovebox 51. The gas supply unit 57 supplies an inert gas to the glovebox chamber of the glovebox. The gas supply unit 57 includes, for example, an inert gas container and a valve. The inert gas may be, for example, helium gas.

Cryocooler Maintenance Method

A cryocooler maintenance method will now be described with reference to FIGS. 15 to 17.

In the following example, replacement of the first displacer 31A and the first driver 31B of the first cryocooler 31 mounted on the cooling subject 30 with the new second displacer 41A and the new second driver 41B will be described. As shown in FIG. 15, the glovebox 51 is joined to the cooling subject 30 and a cooling tank 60. The cooling tank 60 is filled with a coolant 61 for cooling the second cryocooler 41. The coolant 61 may be, for example, liquid nitrogen. In the second cryocooler 41, the cylinder 42 is disposed in the coolant 61, so that the second displacer 41A in the cylinder 42 is cooled by the coolant 61.

The glovebox 51 is joined to the cooling subject 30 by the first attachment portion 55A. The glovebox 51 is also joined to the cooling tank 60 by the second attachment portion 55B. When the first displacer 31A of the first cryocooler 31 is drawn out from the cylinder 32, the glovebox chamber of the glovebox 51 is connected to the cylinder chamber of the cylinder 32. Also, when the second displacer 41A of the second cryocooler 41 is drawn out from the cylinder 42 cooled by the cooling tank 60, the glovebox chamber of the glovebox 51 is connected to the cylinder chamber of the cylinder 42.

As shown in FIG. 16, the first displacer 31A or both the first displacer 31A and the first driver 31B of the first cryocooler 31 are received in the first container 53A, and the second displacer 41A or both the second displacer 41A and the second driver 41B of the second cryocooler 41 are received in the second container 53B. At this time, a first person inserts one hand into the first glove 52AR through the first insertion opening 51AR and the other hand into the second glove 52AL through the second insertion opening 51AL. A second person inserts one hand into the first glove 52BR through the first insertion opening 51BR and the other hand into the second glove 52BL through the second insertion opening 51BL.

The first person draws out the first displacer 31A of the first cryocooler 31 from the cylinder 32 and accommodates the first displacer 31A or both the first displacer 31A and the first driver 31B of the first cryocooler 31 into the first container 53A. At this time, the first displacer 31A of the first cryocooler 31 is accommodated in the stretchable portion 53AA, and the first driver 31B is in contact with the sealing portion 53AB. The opening of the stretchable portion 53AA is sealed by the sealing portion 53AB. When both the first displacer 31A and the first driver 31B are accommodated in the stretchable portion 53AA, a separate sealing member may be provided in the glovebox 51, and the opening of the stretchable portion 53AA may be sealed using the sealing member and the sealing portion 53AB. Subsequently, the first person closes the opening of the cylinder 32 with the first lid 54A. A second person draws out the second displacer 41A of the second cryocooler 41 from the cylinder 42 in the cooling tank 60 and accommodates the second displacer 41A or both the second displacer 41A and the second driver 41B of the second cryocooler 41 in the second container 53B. At this time, the second displacer 41A of the second cryocooler 41 is accommodated in the stretchable portion 53BA, and the second driver 41B is in contact with the sealing portion 53BB. The opening of the stretchable portion 53BA is sealed by the sealing portion 53BB. When both the second displacer 41A and the second driver 41B are accommodated in the stretchable portion 53BA, a separate sealing member may be provided in the glovebox 51, and the opening of the stretchable portion 53BA may be sealed using the sealing member and the sealing portion 53BB. Subsequently, the second person closes the opening of the cylinder 42 in the cooling tank 60 with the second lid 54B.

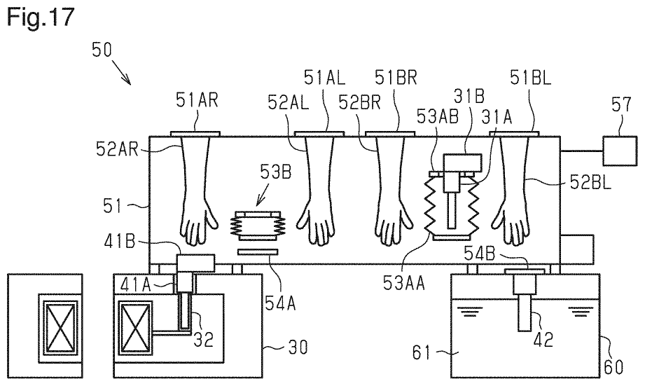

As shown in FIG. 17, the second displacer 41A of the second cryocooler 41 is inserted into the cylinder 32 of the cooling subject 30. At this time, with the first glove 52AR and the second glove 52AL worn, the second person draws out the second displacer 41A of the second cryocooler 41 from the second container 53B. The first person inserts the second displacer 41A of the second cryocooler 41 into the cylinder 32 coupled to the cooling subject 30. Thus, the first displacer 31A and the first driver 31B of the first cryocooler 31 mounted on the cooling subject 30 is replaced with the new second displacer 41A and the new second driver 41B.

In the third embodiment of the maintenance method, a task related to the maintenance may be performed by a single person. In this case, the person may dismount the first displacer 31A and the first driver 31B, accommodate the first displacer 31A and the first driver 31B, dismount the second displacer 41A and the second driver 41B, accommodate the second displacer 41A and the second driver 41B, and mount the second displacer 41A and the second driver 41B.

As described above, the third embodiment of the maintenance apparatus and the maintenance method has the following advantage in addition to the advantages (1) to (3).

(6) Two people may simultaneously perform the task, so that the time taken for the maintenance is shortened.

Modified Examples

The embodiments may be modified as follows. The above embodiments and the following modifications may be combined as long as the combined modifications remain technically consistent with each other.

Cooling Device

The precooling device 40 used in the maintenance method of the first embodiment may be changed to the cooling tank 60 used in the maintenance method of the third embodiment. Even in this case, the second cryocooler 41 is cooled.

Cooling Tank

The cooling tank 60 used in the maintenance method of the third embodiment may be changed to the precooling device 40 used in the maintenance method of the first embodiment. Even in this case, the second cryocooler 41 is cooled.

Second Lid

The second lids 24 and 54B may be omitted from the maintenance apparatuses 10 and 50. Even in this case, collection of moisture on the cylinder 32 is limited by the maintenance apparatuses 10 and 50 including the first lids 14 and 54A.

First Container

The first containers 13 and 53A may be omitted from the maintenance apparatuses 10 and 50. Even in this case, collection of moisture on the second displacer 41A is limited by the maintenance apparatuses 10 and 50 including the second containers 23 and 53B.

Containers

In the third embodiment, the sealing portions 53AB and 53BB may be omitted from the containers 53A and 53B. Even in this case, the cryocoolers 31 and 41 are accommodated in the spaces of the containers 53A and 53B, so that collection of moisture on the cryocoolers 31 and 41 is limited.

The containers 13, 23, 53A, and 53B do not have to be stretchable. Even in this case, the containers 13, 23, 53A, and 53B have accommodation spaces configured to accommodate the first displacer 31A (or the first displacer 31A and the first driver 31B) or the second displacer 41A (or the second displacer 41A and the second driver 41B). Thus, collection of moisture on the first displacer 31A and the second displacer 41A that are accommodated is limited.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A maintenance apparatus for a cryocooler, the maintenance apparatus comprising:
a glovebox configured to be joined to a cooling subject coupled to a cylinder of the cryocooler, the glovebox defining a first glovebox chamber that accommodates a cryocooler part excluding the cylinder, the cryocooler part including a displacer of the cryocooler dismounted from the cylinder;
a container disposed in the first glovebox chamber and configured to accommodate the cryocooler part; and
a lid disposed in the first glovebox chamber, wherein
the lid is configured to disconnect a cylinder chamber of the cylinder from the first glovebox chamber when the cooling subject is joined to the glovebox.

2. The maintenance apparatus according to claim 1, wherein
the cryocooler includes a driver that drives the displacer, and
the glovebox includes
a hole that allows the displacer and the driver to pass through, and
an attachment portion surrounding the hole and configured to hermetically attach the glovebox to the cooling subject.

3. The maintenance apparatus according to claim 1, wherein
the glovebox includes a first glovebox,
the container includes a first container,
the maintenance apparatus further comprises:
a second glovebox configured to be joined to the cooling subject and defining a second glovebox chamber connectable to the cylinder chamber; and
a second container disposed in the second glovebox chamber, and
the second container is configured to accommodate a second displacer configured to be mounted on the cylinder coupled to the cooling subject.

4. The maintenance apparatus according to claim 1, wherein the container includes a stretchable portion that defines a space in the container for accommodating the displacer.

5. The maintenance apparatus according to claim 1, wherein
the cryocooler includes a driver that drives the displacer,
the container is configured to accommodate the displacer while exposing the driver from the container, and
the container includes a sealing portion that contacts the driver and seals a space accommodating the displacer when the displacer is accommodated in the container.

6. A method for maintaining a cryocooler, the method comprising:
joining a glovebox defining a first glovebox chamber to a cooling subject coupled to a cylinder of the cryocooler;
dismounting a displacer of the cryocooler from the cylinder;
accommodating the displacer in a container disposed in the first glovebox chamber; and
disconnecting the first glovebox chamber from a cylinder chamber of the cylinder using a lid provided in the first glovebox chamber.
